(19) United States
(12) Patent Application Publication
(10) Pub. No.: US 2013/0308822 A1
(43) Pub. Date: Nov. 21, 2013

(54) METHOD AND SYSTEM FOR CALCULATING THE GEO-LOCATION OF A PERSONAL DEVICE

(71) Applicants: David Marimon, Madrid (ES); Tomasz Adamek, Madrid (ES)

(72) Inventors: David Marimon, Madrid (ES); Tomasz Adamek, Madrid (ES)

(73) Assignee: TELEFONICA S.A., Madrid (ES)

(21) Appl. No.: 13/825,754

(22) PCT Filed: Jul. 5, 2011
(86) PCT No.: PCT/EP2011/003327

§ 371 Date: Jul. 31, 2013

Related U.S. Application Data
(60) Provisional application No. 61/385,772, filed on Sep. 23, 2010.

(51) Int. Cl. G06K 9/32

(52) U.S. Cl. CPC G06K 9/3241
USPC 382/103

(57) ABSTRACT

The method comprises performing said calculation by using data provided by an image recognition process which identifies at least one geo-referenced image of an object located in the surroundings of said personal device. The system is arranged for implementing the method of the present invention.

### FIELD OF THE ART

The present invention generally relates, in a first aspect, to a method for calculating the geo-location of a personal device and more particularly to a method which comprises performing said calculation by using data provided by an image recognition process which identifies at least one geo-referenced image of an object located in the surroundings of said personal device.

A second aspect of the invention relates to a system arranged for implementing the method of the first aspect.

### PRIOR STATE OF THE ART

During 2009 and 2010 there has been an explosion of commercial outdoor Mobile Augmented Reality (MAR) applications that commonly depend on GPS antennas, digital compasses and accelerometers embedded in mobile devices. These sensors provide the geo-location of the mobile user and the direction towards which the camera of the device is pointing. This direction is enough to show geo-located points of interest (POIs) on the mobile display overlaid to the video feed from the camera.

Due to non-accurate readings, the 2D placement of POIs on the display can be uncorrelated with reality. This is especially dramatic for POIs that are close to the user. We could easily imagine the situation where a GPS provides a location that is on the other side of the corner in a POI-crowded area. The display would not provide information about the POI that is just in front of the user. Such situation can impoverish not only user experience but also hyper-local Mobile AR services.

Recent research on outdoor augmented reality has mostly focused on visually recognizing and registering pose to natural features in the scene [4] [8] [1]. Although highly accurate 6DOF pose estimation can be achieved, those techniques rely on available sets of images of those landmarks that are being augmented.

However, the current situation of MAR applications is slightly different. As a matter of fact, most displayed POIs come from data sets with no reference image (or at least not necessarily one of its outside facade). Fortunately, there exist data sets of images that are geo-referenced (e.g. Panoramio, www.Panoramio.com).

Outdoor AR with Computer Vision

Recent advances in computer vision have enabled online tracking of natural features for outdoor augmented reality [4] [1]. Reitmayr and Drummond [4] presented an edge-based approach to track street facades based on a rough 3D model. This approach was further enhanced with an initialization mechanism based on an accurate GPS antenna [5].

More recently, Arth et al. [1] presented a 6DOF tracking algorithm that performs wide area localization based on Potentially Visible Sets of 3D sparse reconstructions of the environment. The system runs on a mobile device and counts on external initialization. For outdoors, the authors propose to employ GPS. The methods cited above are focused on precise online tracking where reference features are available on the device prior to start tracking.

Visual Recognition of Landmarks

Another path to offer augmentation of the video feed is by recognizing landmarks in front of the camera. Instead of online tracking and registering, pose is computed by detection. In this regard, Schindler et al. [7] presented a recognition method for large collections of geo-referenced images.

The method builds on vocabulary trees of SIFT features [2] and inverted file scoring as in [3]. Takacs et al. [8] present a system that performs keypoint-based image matching on a mobile device. In order to constrain the matching, the system quantizes the user's location and only considers nearby data. Features are cached based on GPS and made available for online identification of landmarks. Information associated to the top ranked reference image is displayed on the device.

Problems with Existing Solutions

The methods described above have several limitations:

Systems relying solely on GPS do not provide acceptable user experience due to the very limited accuracy of the GPS information.

Systems relying on visual recognition of POIs require that each POI to be displayed has at least one reference image with very accurate GPS information. They do not benefit from geo-located reference images that are not related to any POI.

Many MAR systems perform the visual recognition on the mobile side. Due to computational limitations of the mobile devices the recognition methods that can be used within such architectures are sub-optimal.

The existing systems are not capable of fusing geo-localization information from multiple geo-located reference images to improve the accuracy of the geo-location of the query image.

In fact, most of the existing systems use either the GPS information or the results of visual recognition, and are unable to fuse both sources of information.

### DESCRIPTION OF THE INVENTION

It is necessary to offer an alternative to the state of the art which covers the gaps found therein, particularly related to the lack of proposals which really allow geo-locating a user with precise coordinates in an efficient way.

To that end, the present invention provides, in a first aspect a method for calculating the geo-location of a personal device. On contrary to the known proposals, the method of the invention, in a characteristic manner it further comprises performing said calculation by using data provided by an image recognition process which identifies at least one geo-referenced image of an object located in the surroundings of said personal device.

Other embodiments of the method of the first aspect of the invention are described according to appended claims 2 to 7, and in a subsequent section related to the detailed description of several embodiments.

A second aspect of the present invention generally comprises a method for calculating the geo-location of a personal device. On contrary to the known proposals, the method of the invention, in a characteristic manner it further comprises performing said calculation by using data provided by a visual recognition module which identifies at least one geo-referenced image of an object located in the surroundings of said personal device.

Other embodiments of the system of the second aspect of the invention are described according to appended claims 9 to 19, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows the block diagram of the architecture of the system proposed in the invention.

### DETAILED DESCRIPTION OF SEVERAL EMBODIMENTS

Next, a description of the invention for several embodiments will be done, referring the appended Figures.

This invention describes a method and system to estimate the geo-location of a mobile device. The system uses data provided by an image recognition process identifying one or more geo-referenced image(s) relevant to the query, and optionally fuses that data with sensor data captured with at least a GPS antenna, and optionally accelerometers or a digital compass available in the mobile device. It can be used for initialization and re-initialization after loss of track. Such initialization enables, for instance, correct 2D positioning of POIs (even for those without a reference image) on a MAR application.

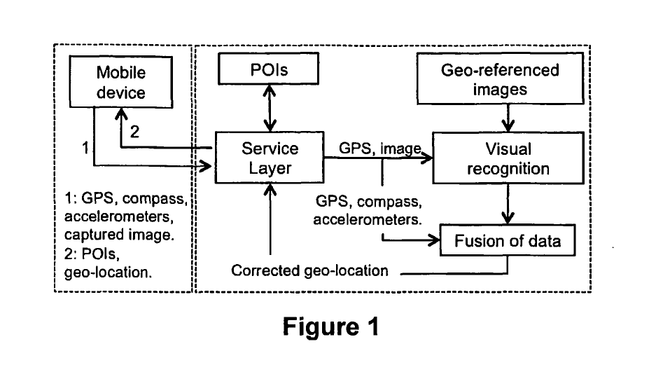

This invention describes a method to calculate the geo-location of a mobile device and a system to employ this calculation to display geo-tagged POIs to a user on a graphical user interface. It also covers a particular implementation with a client-server framework where all the computation is performed on the server side. It was shown on FIG. 1 the block diagram of the generic architecture of such a system. The process has the following flow:

1. The mobile device sends at least a captured image. It can also send readings from the GPS antenna, the digital compass and/or accelerometers.

2. The Service Layer is a generic module responsible for providing information to the mobile device. The Service Layer forwards the information received by the mobile device to the Visual Recognition module.

3. The Visual Recognition module matches the incoming image with a dataset of indexed geo-references images. The Visual Recognition module can optionally employ GPS data to restrain the search to those images that are close to the query.

4. The Fusion of Data module is then responsible for providing an estimation of the geo-location of the device. To do it, the Fusion uses at least the result of the Visual Recognition module. Optionally, it can combine the result of the Visual Recognition module with GPS data. In that case, it can also combine those two inputs with the readings of the digital compass. Also, the combination can be extended with the readings of the accelerometers.

5. The Service Layer can do as simple operations as forwarding the corrected geo-location to the mobile device. However, in a more advanced implementation, it can provide the mobile application with a list of POIs and, optionally, the corrected geo-location.

This Visual Recognition module is the core technology that identifies similar images and their spatial relation with respect to the image captured by the mobile device. The invented method covers the use of any visual recognition engine that indexes a database of geo-referenced images and can match any query image to that database of geo-referenced images. This invention covers any fusion of data that combines at least geo-referenced images. Next, it will be described a particular embodiment of a fusion that combines geo-referenced images with GPS and compass data:

This invention covers any Service Layer that provides POIs to a mobile device whether they are displayed as a list, in a map, with Augmented Reality or any other display method.

The module that fuses data is responsible for obtaining the corrected longitude and latitude coordinates. The proposed method projects all sensor data into references with respect to a map of longitude and latitude coordinates. For each reference image that matches the query, according to the visual recognition engine, a geometric spatial relation in the form of a transformation can be obtained. This transformation can be any among translation, scaling, rotation, affine or perspective. In order to compute this transformation, this proposal covers both the cases where the calibration of the camera that took each of the managed images (references or query) is available and the case where this information is not available.

The transformation provides one aspect that is relevant for this system: scale (λ). Scale is used here to determine how close the user is to a location where a reference image in the database was taken. Since scale cannot be translated to GPS coordinates, it is transformed into a measure of belief. Translation, on the other hand, is of little use in general since a simple camera panning motion could be confused with user's displacement. Therefore, the method described in this invention does not transform that into a change in geo-coordinates. For rotation, a similar rationale is followed.

The compass and accelerometers are used to determine the direction of sight onto the 2D map. This direction provides further belief on scale changes depending on the coordinates of each matched images iₖ and those provided by the GPS antenna s of the mobile device.

The process of fusion consists in the following steps:

1. Establish the vector \vec{ν} from s to iₖ.

2. Establish the angle θ between the direction of sight and \vec{ν}.

3. Determine the influence factor of s and iₖ depending on angle and scale.

4. Compute the influence of matched image k.

5. Repeat the steps 1 to 4 for each matched image.

6. Compute the longitude and latitude by considering all the K contributions.

K is the number of top-ranked reference images considered. K can be chosen experimentally depending on scored recognition level.

The influence factor of each matched image nₖ is defined by the following cases:

nₖ=\sqrt{w}/K if θε[−π/4, π/4] and λ≧1, or if θε[3π/4, 5π/4] and λ≦1, or

nₖ=w/K otherwise;

where

$$w = {e}^{\_ {( λ - 1 )}^{2} / {σ}^{2}}$$

$$for$$

$$λ ε [ 0 , 2 ]$$

and w=0 otherwise, σ is chosen experimentally maintaining a narrow bell shape in w.

This influence factor nₖ permits to limit the contribution of recognition to those matched images that have similar scale and therefore were probably taken from a place close to that of the query.

Corrected coordinates are obtained considering all nₖ influences together with GPS:

$$( longitude , latitude ) = {\sum }_{k} ( {n}_{k} \cdot {i}_{k} + ( {K}^{- 1} - {n}_{k} ) \cdot s )$$

A possible extension of this fusion is to exploit the GPS information available from the mobile device. The extension consists of constraining the recognition process to those reference images that were captured close to the query image. The radius of images constrained is a design parameter. This invention covers also this extension.

Next, it will be described a system that uses the method described above in a Mobile Augmented Reality application:

In current commercial Mobile Augmented Reality (MAR) applications, POIs are shown on the display overlaying the video feed provided by the camera. In order to correctly align the displayed data with respect to reality, the device uses the GPS antenna, the digital compass and accelerometers embedded in the device. In this way, as the user points towards one direction, only POIs that can be found in approximately that direction are shown on the screen.

The generic system described in the previous section is used for MAR. In that case, the mobile device can send images captured by the camera. This can be repeated at a certain time interval, or performed only once (at initialization or after loss of track). This transmission can be set manually or automatically.

Concerning the Service Layer, information such as text description, images, navigation paths, etc., can be provided in an AR graphical user interface.

The Service Layer can use different information sources:

1. Only GPS data available

2. GPS data+geo-referenced images not related to any POI

3. GPS+geo-referenced images not related to any POI+geo-referenced images related to some POIs.

In the first case, the GPS can already provide an initial accuracy that is enough for simple MAR applications (such as the currently commercialized).

In the second case, the visual recognition and fusion of data modules are used to improve the geo-localization of the mobile device. The provided service benefits from this enhanced geo-localization providing a better experience for the user. More precisely, if the estimation of the geo-location is more accurate, the alignment in the display of the POIs with respect to the objects/places in the real world will be more exact.

In the third case, not only the alignment is better but the information relative to a POI can be perfectly aligned with reality since the visual recognition identifies the place that is viewed by the camera.

### ADVANTAGES OF THE INVENTION

Although there are good reasons in MAR for balancing the computation towards the mobile device (such as scalability and latency), this method is designed for initial localization. Therefore, little bandwidth is consumed (circa 50-75 KB) and delay during this phase is not so critical for the user. As a counterpart, with the invented architecture, the system gains database flexibility and can perform more complex visual recognition tasks regardless of the mobile computing power.

In addition, the invented method is complementary with respect to the approaches described in the previous section. On one hand, this approach could be used for initialization on those online tracking algorithms running on mobile phones were real-time registration is key for the AR experience (e.g. [1] [4]). On the other hand, as stated in the previous section, the system proposed cannot only display the POIs that are image-tagged (as in [8]) but also those that do not have a reference image.

Another advantage of this invention is that it does not rely on calibrated images, neither on the query image (coming from the mobile device) nor on the dataset of geo-referenced images. This is not the case of the methods described in [1] [4].

A person skilled in the art could introduce changes and modifications in the embodiments described without departing from the scope of the invention as it is defined in the attached claims.

### ACRONYMS AND ABBREVIATIONS

6DOF SIX DEGREES OF FREEDOM
AR AUGMENTED REALITY
GPS GLOBAL POSITIONING SYSTEM
MAR MOBILE AUGMENTED REALITY
POI POINT OF INTEREST
SIFT SCALE-INVARIANT FEATURE TRANSFORM

### REFERENCES

[1] C. Arth, D. Wagner, M. Klopschitz, A. Irschara, D. Schmalstieg, Wide area localization on mobile phones, Proc. Intl. Symp. on Mixed and Augmented Reality (ISMAR), 2009.
[2] D. Lowe, Distinctive image features from scale-invariant keypoints, Intl. Journal of Computer Vision, Vol. 60, Issue 2, pages 91-110, 2004.
[3] D. Nister, and H. Stewenius, Scalable Recognition with a Vocabulary Tree, Proc. Computer Vision and Pattern Recognition (CVPR), 2006.
[4] G. Reitmayr and T. Drummond, Going out: Robust Tracking for Outdoor Augmented Reality, Proc. Intl. Symp. on Mixed and Augmented Reality (ISMAR), 2006
[5] G. Reitmayr and T. Drummond, Initialisation for Visual Tracking in Urban Environments, Proc. Intl. Symp. on Mixed and Augmented Reality (ISMAR), 2007.
[6] J. Philbin and O. Chum and M. Isard and J. Sivic and A. Zisserman, Object Retrieval with Large Vocabularies and Fast Spatial Matching, Proc. Computer Vision and Pattern Recognition (CVPR), 2007.
[7] G. Schindler and M. Brown and R. Szeliski, City-Scale Location Recognition, Proc. Computer Vision and Pattern Recognition (CVPR), 2007.
[8] G. Takacs, V. Chandrasekhar, N. Gelfand, Y. Xiong, W-C. Yingen Chen, T. Bismpigiannis, R. Grzeszczuk, K. Pulli, B. Girod, Outdoors augmented reality on mobile phone using loxel-based visual feature organization, Proc. Multimedia Information Retrieval, 2008.

1.-19. (canceled)

20. A method for calculating the geo-location of a personal device that comprises:
performing said calculation by using data provided by an image recognition process which identifies at least one geo-referenced image of an object located in the surroundings of said personal device; taking said image of an object located in the surroundings of said personal device with said personal device and matching said image with a dataset of indexed geo-referenced images;
wherein said calculation further comprises using the results of said image recognition fused with information provided by a GPS antenna available in said personal device; and
using the information of an accelerometer or a digital compass available in said personal device in order to perform said calculation, characterized in that the coordinates of said geo-location of said personal device are calculated according to the following formula:
$$( longitude , latitude ) = {\sum }_{k} ( {n}_{k} \cdot {i}_{k} + ( {K}^{- 1} - {n}_{k} ) \cdot s )$$
$$where$$
$$\begin{matrix}{n}_{k} = \sqrt{w} / K if θ • [ - π / 4 , π / 4 ] \\ and \\ λ \geq 1 , or if θ • [ 3 π / 4 , 5 π / 4 ] and λ \leq 1 , or \\ {n}_{k} = w / K otherwise ; \\ w = {e}^{\_ {( λ - 1 )}^{2} / {σ}^{2} } \\ for λ ɛ [ 0 , 2 ] and w = 0 otherwise ;\end{matrix}$$
σ is chosen experimentally maintaining a narrow bell shape in w;
λ is the scale that determines the distance of said personal device to a geo-referenced image;
K is the number of top-ranked images considered in said matching;
θ is the angle between the direction of sight and \vec{ν};
\vec{ν} is the vector from s to iₖ;
iₖ are the coordinates of each of said matched images; and
s are the coordinates of said personal device provided by said GPS antenna.

21. A method as per claim 20, comprising employing said calculation to display geo-tagged Points of Interest (POI) on a graphical user interface of said personal device.

22. A method as per claim 20, comprising constraining said image recognition process to those geo-referenced images placed in a certain radius from said image of an object located in the surroundings of said personal device.

23. A system for calculating the geo-location of a personal device, the system performing said calculation by using data provided by a visual recognition module which identifies at least one geo-referenced image of an object located in the surroundings of said personal device.

24. A system as per claim 23, comprising implementing said system in a client-server framework where said calculation is performed on the server side.

25. A system as per claim 24, comprising using a service layer module which at least:
provides information of the geo-location to said personal device; and
forwards the information received from said personal device to said visual recognition module.

26. A system as per claim 24, wherein said visual recognition module employs GPS information provided by said personal device to restrain said identification to those images located in the surroundings of said object.

27. A system as per claim 25, wherein said service layer provides said personal device with a list of POIs.

28. A system as per claim 25, wherein said service layer provides said personal device with a map of POIs.

29. A system as per claim 27, wherein said list and/or map of POIs is displayed on a graphical user interface of said personal device.

30. A system as per claim 25, wherein said service layer provides said personal device with a view of Points of Interest (POIs) that are displayed superimposed to the image provided by a camera of said personal device on a graphical user interface of said personal device.

31. A system as per claim 27, wherein said list, map or view of Points of Interest (POIs) provided by said service layer to said personal device contains geo-tagged information of said POIs.

32. A system as per claim 24, comprising using a fusion of data module which provides an estimation of the geo-location of said personal device using at least the result of said visual recognition module.

33. A system as per claim 32, wherein said fusion of data module combines the result of said visual recognition module with GPS information provided by said personal device.

34. A system as per claim 33, wherein said fusion of data module further uses data provided by compass or accelerometers of said personal device when performing said combination.
